(19) United States
(12) Patent Application Publication
(10) Pub. No.: US 2006/0228947 A1
(43) Pub. Date: Oct. 12, 2006

(54) Poke-in wire connector and contact therefor

(75) Inventors: John Michael Landis, Camp Hill, PA (US); William Gary Lenker, Marysville, PA (US)

Correspondence Address: Robert J. Kapalka;Tyco Electronics Corporation, Suite 140, 4550 New Linden Road, Wilmington, DE, 19808, US

(73) Assignee: Tyco Electronics Corporation

(21) Appl. No.: 11/103,225

(22) Filed: Apr. 11, 2005

(51) Int. Cl. H01R 9/03

(52) U.S. Cl. 439/610

(57) ABSTRACT

A poke-in wire contact is provided for a wire having an exposed conductor that includes a body extending along, and defining a plane, and a wire termination portion. The wire termination portion includes a recess extending through the body and a termination beam located within the recess and deflectable from the plane of the body. The termination beam is configured to electrically connect to and retain the conductor of the wire. The poke-in wire contact also includes a connection portion extending from the body, wherein the connection portion is configured to be joined to a substrate.

### BACKGROUND OF THE INVENTION

This invention relates generally to electrical connectors, and, more particularly, to poke-in wire connectors for mounting to substrates and connecting wires thereto.

Fluorescent electrical ballasts are used in areas where fluorescent lighting is present, and are typically located within or behind the fluorescent light fixture. Typically, the electrical ballast comprises a long rectangular metal box or “can” with the electrical components mounted inside. A sealer or “potting compound” is then poured into the can which hardens to seal the electrical components within the can. Also typical is to have several discrete wires projecting through the potting material for electrical interconnection thereto. Typically the fluorescent fixture includes complementary discrete wires for interconnection to the discrete wires of the ballast.

A common installation procedure includes stripping a portion of the insulation off of the fixture and ballast wires to expose a portion of the conductor. The ends of the respective ballast and fixture wires are then twisted together, and a plastic threaded nut is then threaded over the twisted conductors. This method of installing or replacing a ballast is very labor intensive, and also it is typically a difficult procedure. Additionally, a given fluorescent light fixture has a predetermined wire configuration and thus requires a corresponding ballast for proper installation or replacement. Thus, the components are not readily interchangeable.

Due to the difficult and labor intensive installation or replacement procedures, at least some known fluorescent light fixtures utilize a so-called wire-trap or poke-in style connection wherein a wire can be inserted into an electrical connector and trapped on the connector using a resilient component. This type of electrical connection requires that the end of the insulation of an insulated wire be stripped, usually to a predetermined length, and then placed into a wire receiving aperture in a connector housing. An electrical terminal or contact having a resiliently bent component traps the wire in place in electrical connection upon pressing the wire into position. Pulling on the wire or strain on the wire causes only a further tightening of the connection. It is also known to incorporate such an electrical connector on a circuit board for a power connection.

However, these known types of connectors have resulted in electrical arcing between the electrical terminals and the metalized can due to the proximity of the electrical terminals and the can. As mentioned above, such terminals are used for power connections, for example, with a ballast-type fluorescent fixture connection, and if the terminals are spaced too close to each other or to the can, electrical current may pass therebetween, which in turn can result in premature failure of the ballast.

An object of at least one embodiment, then, is to provide an electrical connector for use with a ballast-type fluorescent fixture which provides ease of installation and reduces the risk of arcing and other shortcomings in prior art connectors.

### BRIEF DESCRIPTION OF THE INVENTION

In one aspect, a poke-in wire connector is provided having a housing including an insulative body having a contact interface and a wire interface. The housing further includes a wire receiving aperture extending from the wire interface and receiving a wire therein. The connector also includes a contact having a substantially planar body, a connection portion extending from the body, and a wire termination portion having a termination beam configured to retain a conductor of the wire. The contact is received within the housing such that the wire termination portion is substantially aligned with the wire receiving aperture and the connection portion extends through the contact interface of said housing.

Optionally, the housing may include a protrusion extending from the wire interface for a distance, wherein the protrusion defines a portion of the wire receiving aperture. The contact interface may extend substantially perpendicularly with respect to the wire interface. Optionally, the housing may include a front surface, a rear surface generally opposed from the front surface and a bottom surface extending therebetween, wherein the wire interface extends along the front surface, and the contact interface extends along the bottom surface. The wire receiving aperture may extend axially along a centerline, such that a tip portion of the termination beam is substantially aligned with the centerline, wherein the termination beam is deflected as the wire is inserted into the wire receiving aperture.

In another aspect, a poke-in wire connector for a light fixture ballast having a can and a circuit board is provided. The poke-in wire connector includes a contact having a substantially planar body including a recess, a pin extending from the body for surface mounting to the circuit board, and a termination beam within the recess and configured to retain a conductor of a wire. The connector also includes a housing coupled to the can and having an insulative body having a front surface, a rear surface and a bottom surface extending between the front and rear surfaces. The housing also includes a wire receiving aperture extending from the front surface, wherein the wire receiving aperture is configured to receive the wire therein. The housing further includes a contact cavity extending from the bottom surface, wherein the contact cavity is configured to receive the contact therein such that the termination beam is substantially aligned with the wire receiving aperture.

In yet another aspect, a poke-in wire contact is provided for a wire having an exposed conductor that includes a body extending along, and defining a plane, and a wire termination portion. The wire termination portion includes a recess extending through the body and a termination beam located within the recess and deflectable from the plane of the body. The termination beam is configured to electrically connect to and retain the conductor of the wire. The poke-in wire contact also includes a connection portion extending from the body, wherein the connection portion is configured to be joined to a substrate.

### BRIEF DESCRIPTION OF THE DRAWINGS

FIG. 1 is a bottom isometric view of a connector housing formed in accordance with an exemplary embodiment of the present invention.

FIG. 2 is a cutaway view of the connector housing shown in FIG. 1 taken along line 2-2.

FIG. 3 is a front isometric view of a can assembly, including the connector housing shown in FIGS. 1 and 2, formed in accordance with an exemplary embodiment of the present invention.

FIG. 4 is a rear isometric cutaway view of the can assembly shown in FIG. 3.

FIG. 5 is an isometric view of a contact for use with the can assembly shown in FIG. 3 and formed in accordance with an exemplary embodiment of the present invention.

FIG. 6 is a side cross sectional view of the can assembly shown in FIG. 3.

FIG. 7 is an isometric view of an alternative contact formed in accordance with an alternative embodiment of the present invention.

FIG. 8 is a side cross sectional view of the can assembly shown in FIG. 3 and including the alternative contact shown in FIG. 7.

FIG. 9 is a front isometric view of an alternative can assembly formed in accordance with an alternative embodiment of the present invention.

### DETAILED DESCRIPTION OF THE INVENTION

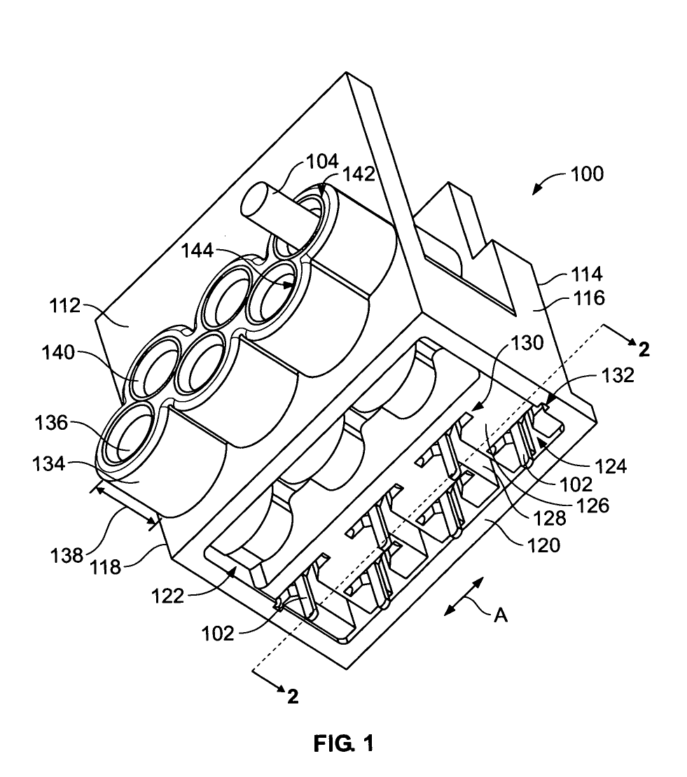

FIG. 1 is a bottom isometric view of a connector housing 100 formed in accordance with an exemplary embodiment of the present invention. The connector housing 100 retains a plurality of contacts 102 therein, and orients the contacts 102 to interface with electrical wires 104, as will be explained below in detail.

The connector housing 100 includes a front surface 112, a rear surface 114 opposite the front surface 112, opposite side walls 116 and 118 extending between the front and rear surfaces 112 and 114, and a bottom portion 120 interconnecting the front and rear surfaces 112 and 114 and the side walls 116 and 118. The connector housing 100 may be fabricated from an insulative material, such as plastic, and may be molded or formed into a predetermined shape and size.

The bottom portion 120 is open and provides access to an interior cavity or receptacle 122. The bottom portion 120 also provides access to a plurality of contact cavities 124 that receive the contacts 102 therein. Each contact cavity 124 includes a contact receiving portion 126 and a channel or void 128 extending from the contact receiving portion toward the rear surface 114. The void 128 provides an area into which a portion of the wire 104 extends beyond the contact 102 when assembled. In an exemplary embodiment, the contact cavities 124 are staggered along the bottom portion 120. Specifically, the contact cavities 124 are oriented along a forward row 130 of contact cavities 124 and a rearward row 132 of contact cavities 124 extending parallel to and spaced apart from one another. Moreover, the contact cavities 124 are axially displaced along a longitudinal direction of the connector housing 100, as shown by arrow A. By staggering the cavities 124 , the spacing between the contacts 102 is increased, thus reducing the risk of electrical arcing between the contacts 102. Additionally, the housing material provides insulation between the contacts 102.

The front surface 112 of the connector housing 100 includes a plurality of housing protrusions 134. Each housing protrusion 134 defines a wire receiving apertures 136 for receiving wires 104 therein. The protrusions 134 may be integrally formed with the connector housing 100 using a molding process. The protrusions 134 extend from the front surface 112 for a distance 138. The distance 138 provides additional material between the wires 104 and the surrounding metal components, thus increasing the creepage distance between the wires 104 and the metal components. As a result, the risk of electrical arcing is reduced.

Each wire receiving aperture 136 includes a beveled surface 140 at a forward end of the apertures 136. The beveled surface 140 guides the wires 104 into the apertures 136. In an exemplary embodiment, the connector housing 100 includes six wire receiving apertures 136 corresponding to the six contacts 102. Alternatively, the connector housing 100 may include greater or fewer than six wire receiving apertures 136. Optionally, the apertures 136 may be staggered along the front surface 112 and may be oriented along an upper row 142 of apertures 136 and a lower row 144 of apertures 136 extending parallel to and spaced apart from one another. As explained below in more detail, each aperture 136 is associated with a corresponding contact 102 and contact cavity 124. It should be noted that the contacts 102 in the forward row 130 of contact cavities 124 are sized smaller than the contacts 102 in the rearward row 132 of contact cavities 124 because the upper row 142 of apertures 136 is staggered with respect to the lower row 144 of apertures 136.

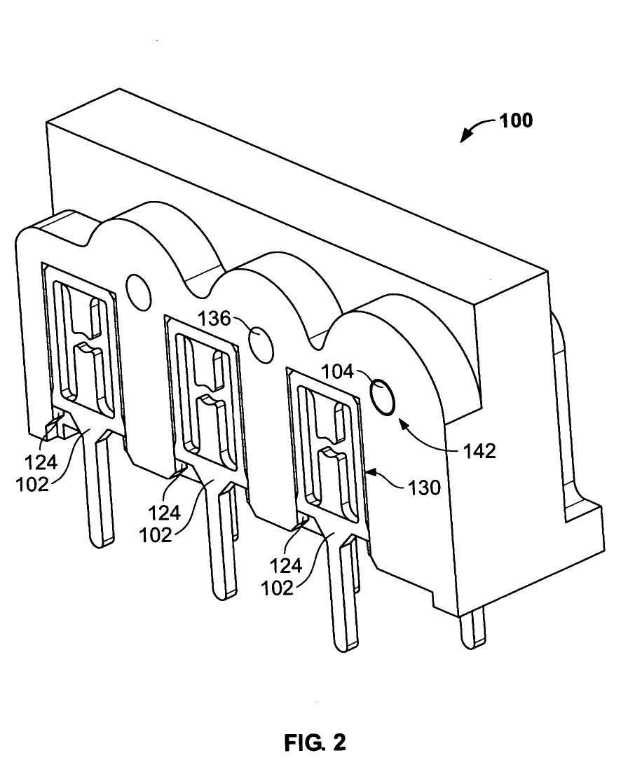

FIG. 2 is a cutaway view of the connector housing 100 taken along line 2-2 shown in FIG. 1 extending through the forward row 130 of contact cavities 124. As illustrated in FIG. 2, each contact cavity 124 includes a contact 102 therein. In one embodiment, the contact cavities 124 are rectangular and substantially aligned with one another. Additionally, the forward row 130 of contact cavities 124 are oriented such that the contact cavities 124 do not interfere with the upper row 142 of wire receiving apertures 136. As such, the wires 104 may extend through the upper row 142 of apertures 136 to the rearward row 132 of contact cavities 124 (shown in FIG. 1).

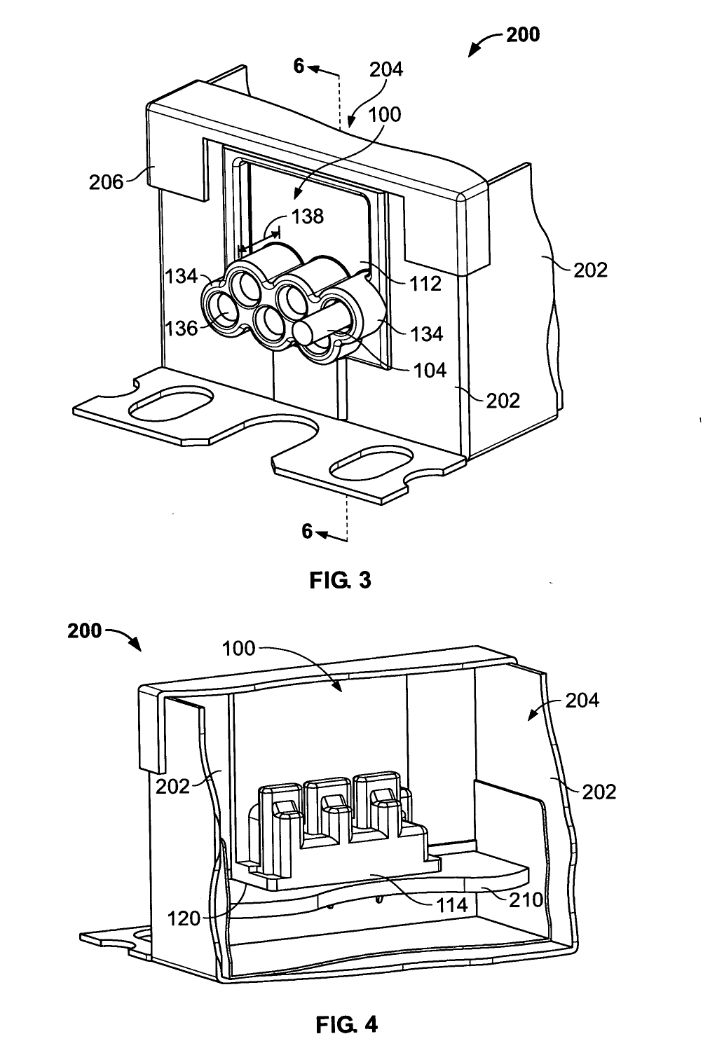

FIG. 3 is a front isometric view of a ballast can assembly 200, including the connector housing 100 and formed in accordance with an exemplary embodiment of the present invention. The can assembly 200 may be used in an electrical component, such as, for example, a fluorescent electrical ballast used in fluorescent lighting applications. The can assembly 200 includes a metalized shell 202 defining a can cavity 204. The connector housing 100 is coupled to the shell 202 such that the front surface 112 of the housing 100 is positioned along the exterior of the can assembly 200 and the rear surface 114 (shown in FIG. 1) is positioned within the can cavity 204. As such, the wires 104 may be loaded into the wire receiving apertures 136 from the exterior of the can assembly 200. Optionally, the can assembly 200 includes a lid or cover 206 for enclosing the can assembly 200. The lid 206 may secure the connector housing 100 to the can assembly 200.

As illustrated in FIG. 3, and as indicated above, the protrusions 134 of the connector housing 100 extend from the front surface 112 for a distance 138 to increase a creepage distance between the wires 104 and the metalized shell 202, thus reducing a risk of electrical arcing. Optionally, less than all of the wire receiving apertures 136 in the protrusions 134 may be utilized depending on the type of application for which the connector housing 100 is being utilized. Alternatively, less than all of the wire receiving apertures 136 in the protrusions 134 may be utilized depending on the type of wire 104 being utilized. In one embodiment, the protrusions 134 may be identified with, for example, a number or a color, to determine which wire receiving aperture 136 to utilize. Multiple wiring configurations allow the connector housing 100 to be utilized for many different types of applications.

FIG. 4 is a rear isometric cutaway view of the can assembly 200 including a substrate, such as a circuit board 210, positioned within the can cavity 204. The circuit board 210 is supported by the shell 202. The bottom portion 120 of the connector housing 100 may be electrically and mechanically coupled to the circuit board 210. The rear surface 114 of the connector housing 100 is sized and shaped to minimize an amount of material used to fabricate the connector housing 100. Specifically, void areas are oriented along connector housing 100 to reduce the amount of material in the connector housing 100. Optionally, a sealer or potting compound (not shown) may be poured into the can cavity 204 which hardens to seal the electrical components within the can assembly 200.

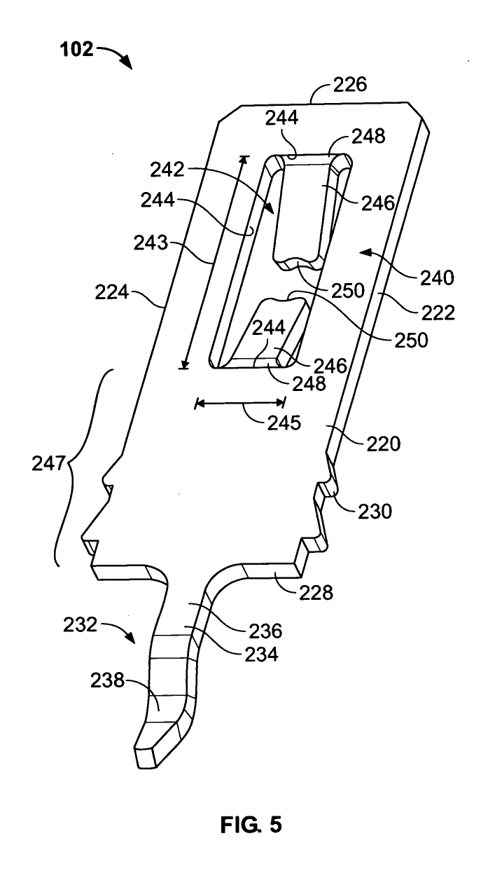

FIG. 5 is an isometric view of an exemplary contact 102 for use with the can assembly 200 (shown in FIG. 3) and formed in accordance with an exemplary embodiment of the present invention. The contact 102 may be stamped and formed metal contact including a body 220 extending along and defining a plane. The contact 102 has longitudinal side walls 222 and 224, and lateral side walls 226 and 228 extending between the longitudinal side walls 222 and 224. Optionally, the contact 102 may be substantially rectangular and may include a plurality of barbs 230 extending from the longitudinal side walls 222 and 224.

The contact 102 includes a connection portion 232 for attachment to a surface of a substrate such as the circuit board 210 (shown in FIG. 3). Optionally, the connection portion 232 may include a pin 234 extending from the body 220 for through-hole mounting to the circuit board 210. The pin 234 may be soldered and/or interference fitted to the circuit board 210. Optionally, the pin 234 may extend from a lateral side wall 226 or 228. In one embodiment, the pin 234 includes a straight portion 236 extending from the side wall 226 or 228 and a rounded portion 238 proximate the distal end of the pin 234. The rounded portion 238 provides an interference or friction fit when mounted to the circuit board 210, as describe in greater detail below. Alternatively, the connection portion 232 may have a flat bottom surface that is soldered to a surface of the circuit board 210.

The contact 102 includes a wire termination portion 240 for electrically and mechanically engaging a wire 104 (shown in FIGS. 1 and 2). In an exemplary embodiment, the wire termination portion 240 allows for a poke-in type of engagement with the wire 104. The wire termination portion 240 includes a recess 242 extending through the planar body 220, and as such is fully surrounded by the body 220. The recess 242 is defined by side walls 244 extending substantially perpendicularly with respect to the planar surfaces of the body 220. Optionally, the recess 242 may be substantially rectangular. In one embodiment, the recess 242 has a height 243 that is between approximately two and four times the diameter of the wire 104 extending therethrough. Additionally, the recess 242 may have a width 245 that is between approximately one and one and a half times the diameter of the wire 104. In one embodiment, the height 243 is approximately one half the length of the longitudinal side wall 222 or 224. Additionally, the width 245 is approximately one third of the length of the lateral side walls 226 or 228. In one embodiment, the recess 242 is positioned proximate the upper lateral side wall 226, generally opposed from the side wall 228 having the connection portion 232. Additionally, an uninterrupted region 247 extends between the lower side wall 228 and the recess 242.

The wire termination portion 240 includes at least one termination beam 246 extending from the side wall 244 of the recess 242. The termination beams 246 may be deflected when the beams 246 interface with the wire 104. Optionally, two termination beams 246 are provided and extend generally toward one another from opposing side walls 244. Specifically, the termination beams 246 extend from a base 248 coupled to the side wall 244 of the recess 242 to a tip 250 located a distance from the base 248. Optionally, the tip 250 may be concave or inwardly sloped for interfacing with the wire 104. In an exemplary embodiment, the termination beams 246 are linear. Alternatively, the termination beams 246 may be curvilinear, or may have another shape. In the illustrated embodiment, the termination beams 246 are in a deflected state, wherein the beams 246 extend obliquely with respect to the plane of the body 220 of the contact 102. As such, the termination beams 246 are angled out of the plane of the body 220. As indicated above, the termination beams 246 are deflected when the beams 246 interface with the wire 104. However, prior to such interfacing, the beams 246 are in an un-deflected or normal state (not shown), wherein the beams 246 are substantially aligned with the plane of the contact 102. Optionally, the tips 250 of the beams 246 may contact one another when the beams 246 are in the un-deflected state.

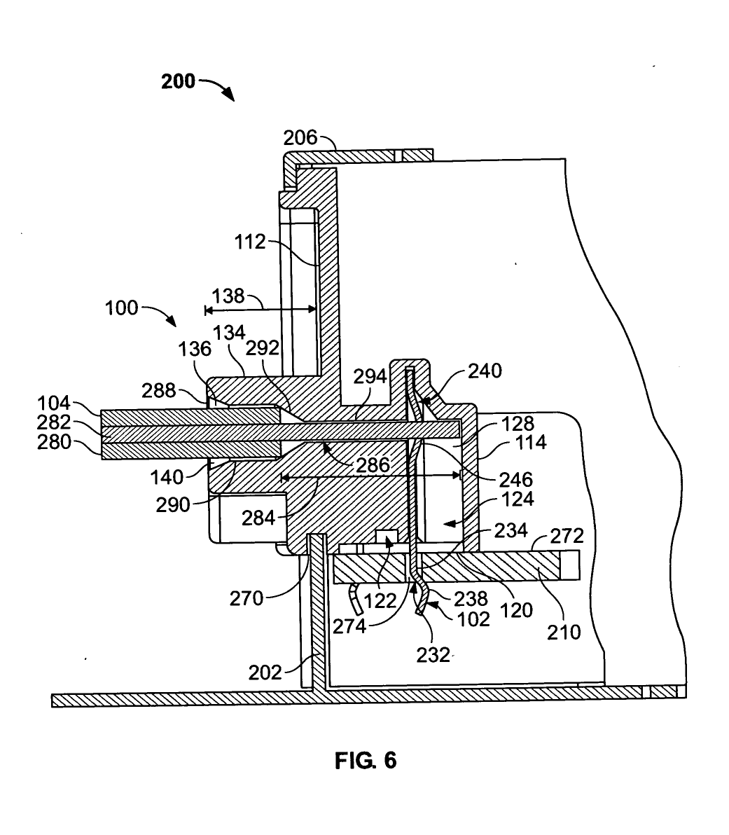

FIG. 6 is a side cross sectional view of the can assembly 200 taken along line 6-6 shown in FIG. 1 and extending through one of the contacts 102 and one of the wires 104. As illustrated in FIG. 6, the connector housing 100 is coupled to the shell 202 and oriented to engage the circuit board 210. Specifically, the connector assembly 100 includes a channel 270 surrounding the shell 202 for securing the connector housing 100 in place with respect to the shell 202. Additionally, the connector housing 100 is secured in place with the lid 206. The protrusions 134 extend outward from the front surface 112 for the distance 138 to increase the distance between the wire 104 and the shell 202. As indicated above, increasing this distance reduces the risk of arcing.

Prior to assembly of the can assembly 200, the contacts 102 are loaded or inserted into the contact cavities 124, and the barbs 230 (shown in FIG. 5) engage the inner surface of the contact cavities 124 to secure the contacts 102 within the contact cavities 124. Once loaded, the wire termination portions 240 of the contacts 102 are substantially aligned with the wire receiving apertures 136 of the connector housing 100. More specifically, the termination beams 246 are aligned with the wire termination apertures 136 such that, when the wire 104 is loaded into the wire receiving aperture 136, as described in more detail below, the wire 104 engages the termination beams 246, and more particularly, deflects the beams 246 toward the rear surface 114 of the connector housing 100. During assembly of the can assembly 200, the connector housing 100, including the contacts 102, is loaded or inserted into position with respect to the shell 202.

When assembled, the bottom portion 120 of the connector housing 100 rests upon an upper surface 272 of the circuit board 210. As such, the potting material is unable to enter or seep into the connector cavity 122 of the connector housing 100. Additionally, the connector housing 100 is oriented with respect to the circuit board 210 such that the contact cavities 124 are substantially aligned with through-holes or vias 274 extending through the circuit board 210. As such, during assembly of the can assembly 200, the contacts 102, and more particularly, the connection portions 232 of the contacts 102, may extend through the vias 274 as the connector housing 100 is loaded into position with respect to the can assembly 200 and the circuit board 210. In one embodiment, the rounded portions 238 of the rearward row 132 of contact cavities 124 face the rear surface 114 of the connector housing 100 and the rounded portions 238 of the forward row 130 of contact cavities 124 face the front surface 112 of the connector housing 100. Once assembled, the rounded portion 238 of the pin 234 may frictionally engage the circuit board 210. Additionally, once assembled, the contact 102 may be soldered to the circuit board 210 to mechanically and/or electrically couple the components to one another.

Once assembled, the connector housing 100 is oriented to receive the wires 104. The wires 104 are prepared for use prior to insertion into the wire receiving apertures 136. Specifically, an insulative cover 280 is stripped from an end of the wire 104 to expose a conductor 282. A predetermined length 284 of the insulative cover 280 is removed such that the conductor interfaces with the contact 102. The wires 104 are then inserted or loaded into the wire receiving apertures 136. In an exemplary embodiment, each wire receiving aperture 136 includes an axial, stepped cylindrical passage 286 extending from an opening 288. A forward portion 290 of the passage 286 includes the beveled surface 140 extending inward from the opening 288. As such, the opening 288 has a greater diameter than the forward portion 290. The passage 286 also includes an inner beveled portion 292 extending between the forward portion 290 and a rearward portion 294. The rearward portion 294 has a reduced diameter as compared to the forward portion 290 and extends to the contact cavity 124. Optionally, the forward and rearward portions 290 and 294, respectively, may be sized differently in respective wire receiving apertures 136, such that adjacent apertures 136 can accommodate different sized wires 104.

When the prepared wire 104 is inserted into the wire receiving aperture 136, the insulative cover 280 extends along the forward portion 290 of the passage 288 and may contact the inner beveled portion 292 which acts as a limit on the depth of insertion of the wire 104. The wire 104 is received and held in the contact 102 in an orientation perpendicular to a plane of the body 220 of the contact 102. Additionally, when the prepared wire 104 is inserted into the wire receiving aperture 136, the conductor 282 extends along the rearward portion 294 of the passage 286 and engages and extends beyond the termination beams 246 into the void 128 of the contact cavity 124. Once the conductor 282 extends beyond the termination beams 246, the termination beams 246 engage the outer portion of the conductor and prevent movement of the conductor 282 in the direction of the front surface 112 of the connector housing 100. As such, removal of the wire 104 is prevented. This poke-in type of connection between the wire 104 and the contact 102 is accomplished in a cost effective and reliable manner.

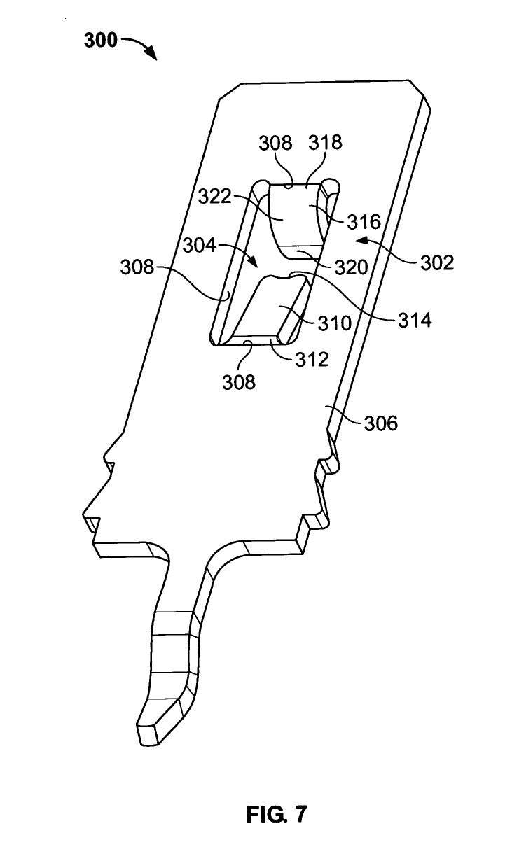

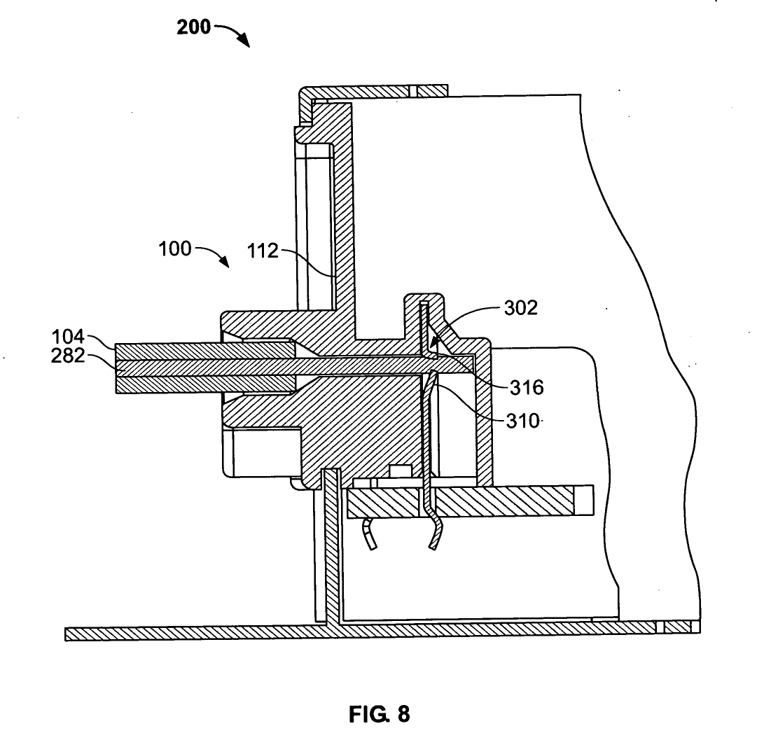

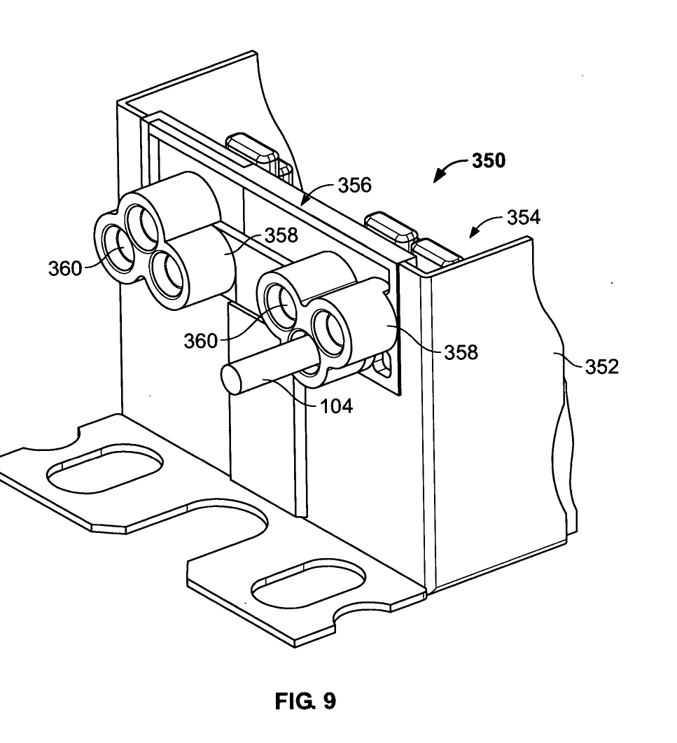

FIG. 7 is an isometric view of an alternative contact 300 formed in accordance with an alternative embodiment of the present invention. FIG. 8 is a side cross sectional view of the can assembly 200 shown in FIG. 3 and including the alternative contact 300. The contact 300 is similar to the contact 102 (shown in FIG. 5), however, the contact 300 has an alternative wire termination portion 302.

The wire termination portion 302 includes a recess 304 extending through a planar body 306, and as such is fully surrounded by the body 306. The recess 304 is defined by side walls 308 extending substantially perpendicularly with respect to the planar surfaces of the body 306. Optionally, the recess 304 may be substantially rectangular.

The wire termination portion 302 includes a first termination beam 310 extending from the side wall 308 of the recess 304. The first termination beam 310 may be deflected when the beam 310 interfaces with the wire 104. The first termination beam 310 is linear and extends from a base 312 to a tip 314 located a distance from the base 312. The wire termination portion 240 also includes a second termination beam 316 extending from the side wall 308 generally opposed from the first termination beam 310. The second termination beam 316 is curved between a base 318 and a tip 320. Specifically, the second termination beam 316 includes a ramp portion 322 defining a platform to support and position the wire 104 with respect to the first termination beam 310. The ramp portion 322 is substantially parallel to the planar body 306 at the base 318 and is substantially perpendicular to the planar body 306 at the tip 320.

As illustrated in FIG. 8, when the wire 104 is loaded into the connector housing 100, the conductor 282 extends beyond the wire termination portion 302 and the first termination beam 310 is deflected. Once inserted, the wire 104 is secured within the connector housing 100 by the termination beams 310 and 316. Specifically, the second termination beam 316 provides a platform for orienting the wire 104 with respect to the first termination beam 310, and the first termination beam 310 engages the conductor 282 and prevents movement of the wire 104 in the direction of the front surface 112 of the connector housing 100.

FIG. 9 is a front isometric view of an alternative can assembly 350 formed in accordance with an alternative embodiment of the present invention. The can assembly 350 includes a metalized shell 352 defining a can cavity 354. Optionally, a lid or cover (not shown) may be included to enclose the can cavity 354. The can assembly 350 also includes a connector housing 356 having a plurality of housing protrusions 358 defining wire receiving apertures 360. The protrusions 358 are clustered together into multiple groups and the groups of protrusions 358 are separated from one another. Optionally, the protrusions 358 may be grouped depending on the type or size of wires 104 to be inserted into the respective wire receiving apertures 360. Alternatively, the protrusions 358 may be grouped depending on the type of can assembly 350 used, or the particular application for which the can assembly 350 may be used.

As such, a connector housing 100 for use with a ballast-type fluorescent fixture is provided in a cost effective and reliable manner. The connector housing 100 includes a plurality of wire receiving apertures 136 for receiving multiple wires 104 in multiple configurations. The wire receiving apertures 136 are aligned with and provide access to contact cavities 124 housing contacts 102 therein. The contacts 102 are poke-in type contacts having substantially planar bodies 220 including termination beams 246 that are deflected when the wire 104 is loaded into the connector housing 100 but that prevent the wire 104 from being removed. As indicated above, the connector housing 100 may be utilized on different types of can assemblies 200 because multiple wiring configurations are allowed by using less than all of the wire receiving apertures 136. Additionally, because the wires 104 are installed after the can assembly 200 is assembled, the connector housing 100 provides ease of installation. Moreover, due to the arrangement and orientation of the wire receiving apertures 136, including the protrusions 134, the connector housing 100 provides adequate creepage distances between the wires 104 and the shell 202 of the can assembly 200. As a result, the risk of electrical arcing or failure of various components is reduced.

While the invention has been described in terms of various specific embodiments, those skilled in the art will recognize that the invention can be practiced with modification within the spirit and scope of the claims.

1. A poke-in wire contact for a wire having an exposed conductor, said contact comprising:
a body extending along, and defining a plane;
a wire termination portion comprising a recess extending through said body and a termination beam located within said recess and deflectable from said plane of said body, said termination beam configured to electrically connect to and retain the conductor of the wire; and
a connection portion comprising a pin extending from said wire termination portion and being substantially planar with said wire termination portion said connection portion further comprising a surface mount portion extending from said pin and being configured to be joined to a substrate.

2. A contact in accordance with claim 1 wherein said wire termination portion is surrounded by said body.

3. A contact in accordance with claim 1 wherein said body comprises front and back surfaces extending substantially parallel to one another, said wire termination portion extending fully between said front and back surfaces.

4. A contact in accordance with claim 1 wherein said termination beam comprises first and second termination beams provided in said recess, each said first and second termination beam being configured to engage the conductor.

5. A contact in accordance with claim 1 wherein said termination beam comprises a base and a tip, said base extending from said body, said tip configured to engage the conductor.

6. A contact in accordance with claim 1 wherein said wire termination portion receives the wire along a direction oriented perpendicular to said plane of said body.

7. A contact in accordance with claim 1 wherein said wire termination portion comprises a platform extending perpendicularly from said body, said termination beam configured to retain the conductor between a tip portion of said termination beam and said platform.

8. A contact in accordance with claim 1 wherein said connection portion comprises a pin having a rounded portion for surface mounting to a circuit board.

9. A poke-in wire connector comprising:
a housing comprising an insulative body having a contact interface and a wire interface, said housing further comprising a wire receiving aperture extending from the wire interface and receiving a wire therein; and
a contact comprising a body extending along and defining a plane, said body comprising a connection portion having a pin extending along the plane and a surface mount portion extending from said pin, and said body comprising a wire termination portion extending along the plane, said wire termination portion comprising a recess and a termination beam located within said recess, said termination beam deflectable from said plane of said body and being configured to retain a conductor of the wire, said contact received within said housing such that said wire termination portion is substantially aligned with said wire receiving aperture and said surface mount portion is positioned proximate said contact interface of said housing.

10. A poke-in wire connector in accordance with claim 9 wherein said housing further comprises a protrusion extending from said wire interface for a distance, said protrusion defining a portion of said wire receiving aperture.

11. A poke-in wire connector in accordance with claim 9 wherein said contact interface extends substantially perpendicularly with respect to said wire interface.

12. A poke-in wire connector in accordance with claim 9 wherein said housing comprises a front surface, a rear surface generally opposed from said front surface and a bottom surface extending therebetween, said wire interface extending along said front surface, said contact interface extending along said bottom surface.

13. A poke-in wire connector in accordance with claim 9 wherein said wire receiving aperture extends axially along a centerline, a tip portion of said termination beam substantially aligned with said centerline such that said termination beam is deflected as the wire is inserted into said wire receiving aperture.

14. A poke-in wire connector in accordance with claim 9 wherein said planar body is oriented substantially parallel to and spaced apart from said wire interface, said termination beam extends obliquely and generally away from said wire interface, said termination beam engages the wire inserted into said wire receiving aperture and resists movement of the wire in the direction of the wire interface.

15. A poke-in wire connector in accordance with claim 9 wherein said housing further comprises a contact cavity extending from said contact interface and substantially parallel to said wire interface, said contact cavity receiving said contact therein.

16. A poke-in wire connector in accordance with claim 9 wherein said contact further comprises a retention barb extending from said body for engaging said housing for retaining said contact therein.

17. A poke-in wire connector for a light fixture ballast having a can and a circuit board, said poke-in wire connector comprising:
a contact comprising a body extending along and defining a plane, said body having a recess, said contact further comprising a termination beam located within said recess and configured to retain a conductor of a wire, and said contact comprising a pin extending from said body and being substantially planar with said body, wherein a portion of said pin defining a surface mount portion for surface mounting to the circuit board; and
a housing coupled to the can and comprising an insulative body having a front surface, a rear surface and a bottom surface extending between said front and rear surfaces, said housing further comprising a wire receiving aperture extending from the front surface and configured to receive the wire therein, said housing further comprising a contact cavity extending from said bottom surface and configured to receive said contact therein such that said termination beam is substantially aligned with said wire receiving aperture.

18. A poke-in wire connector in accordance with claim 17 wherein said body is oriented substantially parallel to and spaced apart from said front surface, said termination beam extends obliquely and generally away from said front surface, said termination beam engages the wire inserted into said wire receiving aperture and resists movement of the wire in the direction of the wire interface.

19. A poke-in wire connector in accordance with claim 17 wherein said termination beam comprises first and second termination beams provided in said recess, each said first and second termination beams configured to engage the conductor.

20. A poke-in wire connector in accordance with claim 17 wherein said termination beam comprises a base and a tip, said base extending from said planar body, said tip configured to engage the conductor.
